(19) United States
(12) Patent Application Publication
(10) Pub. No.: US 2007/0020601 A1
(43) Pub. Date: Jan. 25, 2007

(54) DISPLAY APPARATUS AND TOUCH-BASED METHOD THEREFOR

(76) Inventors: Han-Che Wang, Shenzhen (TW); Shin-Hong Chung, Shenzhen (TW); Kuan-Hong Hsieh, Shenzhen (TW)

Correspondence Address: NORTH AMERICA INTELLECTUAL PROPERTY CORPORATION, P.O. BOX 506, MERRIFIELD, VA, 22116, US

(21) Appl. No.: 11/308,780

(22) Filed: May 3, 2006

(30) Foreign Application Priority Data
Jul. 22, 2005 (CN) 200510036152.8

(51) Int. Cl. G09B 5/00

(52) U.S. Cl. 434/317; 345/901

(57) ABSTRACT

A display apparatus and touch-based method therefor is provided. The touch-based method for the display apparatus includes the steps of: providing the display apparatus, the display apparatus including a screen and a frame, the frame connected to the screen and including a plurality of touch sensitive regions, the touch sensitive regions each having a plurality of second touch sensitive units; receiving and recognizing sensing signals from the touch sensitive unit of the touch sensitive region, in response to a touch operation thereon; and performing a corresponding operation according to the recognized sensing signal. The operation can be an operation of flipping forwards/backwards a page of an electronic book displayed on the screen, or be an operation of scrolling upwards/downwards the page of the displayed electronic book.

### TECHNICAL FIELD

The present invention relates to a display apparatus and touch-based method therefor, and particularly to a display apparatus with touch sensitive units within a frame thereof and a related touch-based method for the display apparatus.

### GENERAL BACKGROUND

Generally, a display apparatus is a device to visually output information or graphics on a screen. It is widely and increasingly used in electronic devices. A first conventional display apparatus includes a screen to display a data (i.e., an image) thereon, and a frame to support the screen. The frame is further disposed a plurality of mechanical function buttons thereon to actuate any desired function. Due to the variation of sizes of the mechanical function buttons, the frame should be designed as large as possible to hold the mechanical function buttons. As a result, a volume of the display apparatus as a whole becomes very large.

A second conventional display apparatus adopts a touch screen for display. The touch screen using graphical user interface (GUI) displays on the display screen thereof buttons for the user to touch directly by the finger or the like for making a selection. However, since the user directly touches the display screen, the touch screen thereupon is easily scratched or damaged.

Therefore, there is a need for an improved display apparatus and touch-based method therefore which can overcome the above-mentioned problems.

### SUMMARY

A display apparatus is provided. The display apparatus includes a screen and a frame. The frame connects to the screen. The frame further includes a plurality of touch sensitive regions. The touch sensitive regions each have a plurality of touch sensitive units, each of which generates sensing signals in response to a touch operation thereon, thereby performing a corresponding operation.

A touch-based method for a display apparatus is also provided. The method includes the steps of: (a) providing a display apparatus, the display apparatus including a screen and a frame, the frame connecting to the screen and including a plurality of touch sensitive regions, the touch sensitive regions each having a plurality of touch sensitive units; (b) receiving and recognizing sensing signals from the touch sensitive unit of the touch sensitive region, in response to a touch operation thereon; and (c) performing a corresponding operation, according to the recognized sensing signal.

Other advantages and novel features will be drawn from the following detailed description with reference to the attached drawings, in which:

### BRIEF DESCRIPTION OF DRAWINGS

FIG. 1 is an exemplary schematic diagram of a display apparatus including a screen and a frame in accordance with a preferred embodiment of the present invention, the frame including two touch sensitive regions thereon, each of which including four touch sensitive units;

FIG. 2 is a block diagram of hardware infrastructure of a sensing signal processing circuit of the touch sensitive unit of FIG. 1, with the signal processing circuit connecting to a processing unit;

FIG. 3 is an exemplary block diagram of a hardware infrastructure of an electronic book reading apparatus, the electronic book reading apparatus including the display apparatus of FIG. 1; and

FIG. 4 is a flowchart of a preferred touch-based method for a display apparatus in accordance with a preferred embodiment of the present invention.

### DETAILED DESCRIPTION

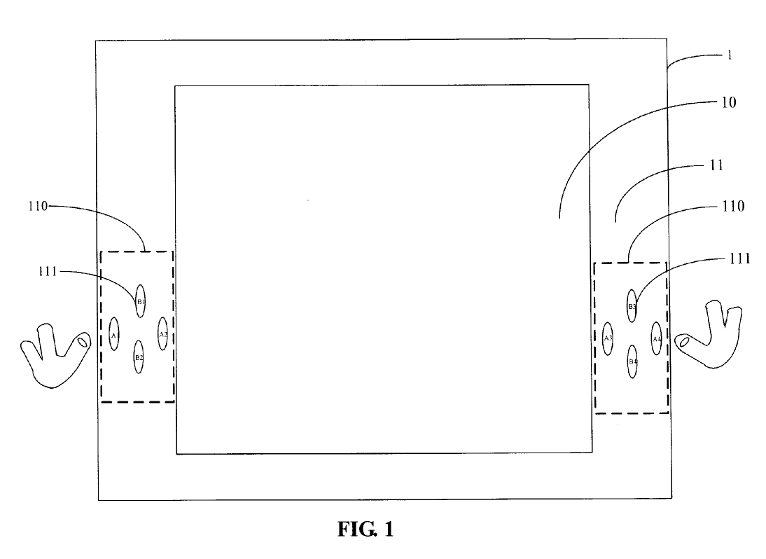

FIG. 1 is an exemplary schematic diagram of a display apparatus in accordance with a preferred embodiment of the present invention. The display apparatus 1 includes a screen 10 and a frame 11. The frame 11 includes two touch sensitive regions 110 (each symbolically indicated with a dashed rectangular outline) thereon. The touch sensitive regions 110 are symmetrically disposed on the frame 11. Furthermore, the touch sensitive regions 110 are preferably located on regions where a user's thumbs can easily touch when holding the display apparatus 1. Each touch sensitive region 110 further has a plurality of touch sensitive units 111 therein.

For simplicity, in such case, each touch sensitive region 110 has four touch sensitive units 111 (symbolically indicated as A1, A2, B1, B2, and A3, A4, B3, B4). Each touch sensitive unit 111 is designated a coordinate for identifying itself. In addition, each touch sensitive unit 111 has a sensing signal processing circuit 112 (described more fully below) for generating sensing signals in response to a touch operation thereon, thereby performing a corresponding operation. That is, each touch sensitive unit 111 serves as a function button. For example, touch sensitive units A1 or A4 are used for flipping forwards a page of an electronic book displayed on the screen 10, whereas touch sensitive units A2 or A3 are used for flipping backwards the page of the displayed electronic book; touch sensitive units B1 or B3 are used for scrolling upwards the page of the displayed electronic book, whereas touch sensitive units B2 or B4 are used for scrolling downwards the page of the displayed electronic book.

The display apparatus 1 further includes a processing unit 12 (not shown). The processing unit 12 receives and recognizes the sensing signals from the touch sensitive unit 111 according to associated coordinates therewith, and performs the corresponding operations. For example, if the sensing signals come from touch sensitive unit A1 or A4, the processing unit 12 flips forwards the page of the displayed electronic book; if the sensing signals come from touch sensitive unit A2 or A3, the processing unit 12 flips backwards the page of the displayed electronic book; if the sensing signals come from touch sensitive unit B1 or B3, the processing unit 12 scrolls upwards the page of the displayed electronic book; and if the sensing signals come from touch sensitive unit B2 or B4, the processing unit 12 scrolls downwards the page of the display electronic book.

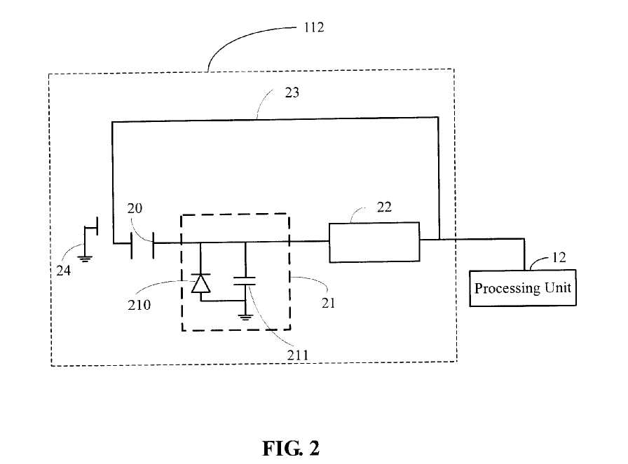

FIG. 2 is a block diagram of hardware infrastructure of a sensing signal processing circuit of the touch sensitive unit of FIG. 1, with the signal processing circuit 112 connecting to the processing unit 12. The sensing signal processing circuit 112 mainly includes an antenna 20, a clamping circuit 21, a detector 22, a feedback line 23, and a grounding line 24. The antenna 20 is connected to the clamping circuit 21. The clamping circuit 21 is connected to an input end of the detector 22. An output end of the detector 22 is respectively connected to the processing unit 12 and one end of the feedback line 23. The feedback line 23 forms a positive feedback circuit with the antenna 21. The grounding line 24, namely a space between two adjacent touch sensitive units, is for spacing the touch sensitive units therebetween.

The human body is itself electrically charged with noise and static signals. Therefore, when a user touches the touch sensitive unit 110 or the touch sensitive regions 111, the noise and static signals of the user flow through the antenna 20. The antenna 20 transmits the noise and static signals to the clamping circuit 21. However, static signals may cause interference to the noise, and may even fry the detector 22. In addition, a strong noise may adversely influence a resulting output for the processing unit; that is, the sensitivity of the touch sensitive unit may be diminished. Accordingly, the clamping circuit 21 is for eliminating static signals and for reducing the noise, thus improving the sensitivity accuracy of the touch sensitive unit. The clamping circuit 21 includes a diode 210, and a capacitor 211. The anode is of the diode 210 is connected to the antenna 20, while the cathode is connected to ground. Upon receiving the noise and static signals, the diode 210 filters out static electrical signals to ground so as to avoid frying the detector 22, and reducing the noise to transmit to the capacitor 211. The capacitor 211 further leaks a portion of the reduced noise to ground. Thus the reduced noise is further weakened, thereby obtaining a more accurate sensitivity. The detector 22 has a high input impedance, so as to easily detect the weakened reduced noise received from the input end of the detector 22. The detector 22 then converts the weakened reduced noise into digital signals, namely the sensing signals, and transmits the digital signals through the output end of the detector 22 to the processing unit 12 for performing corresponding controls. Furthermore, because the feedback line 23 forms a positive feedback circuit with the antenna 20, the noise generated as the user touches the edge of the touch sensitive unit is filtered, thereby further improving the accuracy sensitivity accuracy of the touch sensitive unit.

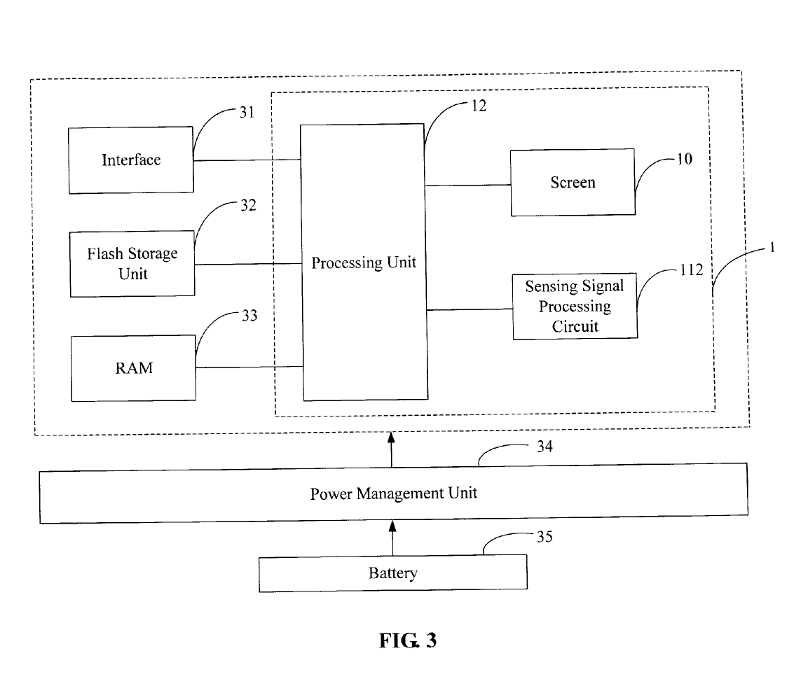

FIG. 3 is an exemplary block diagram of a hardware infrastructure of an electronic book reading apparatus, the electronic book reading apparatus including the display apparatus 1 of FIG. 1. The electronic book reading apparatus (hereinafter, “the reading apparatus”) mainly includes an interface 31, a flash storage unit 32, an RAM 33, a power management unit 34, a battery 35, and the display apparatus 1 of FIG. 1. The display apparatus 1 includes the screen 10, a plurality of sensing signal processing circuits 112 (only one shown), and the processing unit 12 therein.

Referring to FIG. 1, the touch sensitive units 111 are symmetrically disposed on the frame 11 and essentially serve as function buttons. Accordingly, thumbs of a user of the reading apparatus can easily touch the touch sensitive units 111 to perform desired operations when holding the reading apparatus for reading thereon. For example, the user can flip forwards a page of an electronic book displayed on the reading apparatus through touch sensitive unit A1 or A4, conversely, flip backwards the page of the displayed electronic book through touch sensitive unit A2 or A3. Similarly, the user can scroll upwards the page of the displayed electronic book through touch sensitive unit B1 or B3, conversely, scroll downwards the page of the displayed electronic book.

In addition, since the touch sensitive unit 111 has a good sensitivity accuracy thereof, the touch sensitive unit 111 can easily recognize a touch input. Accordingly, the touch sensitive unit 111 can be designed in smaller sizes. Therefore, the frame 11 can be designed in a narrower size, and the display apparatus 1, even the reading apparatus, thereupon shall have a smaller volume.

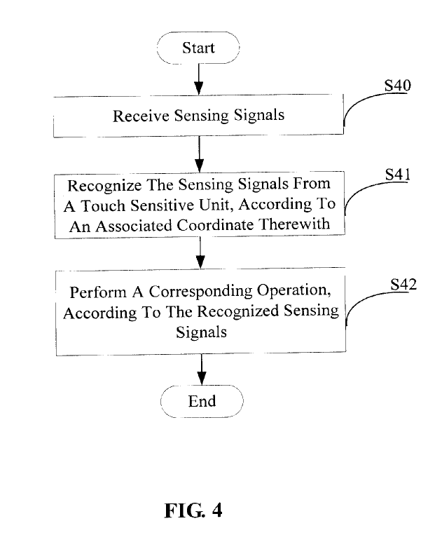

FIG. 4 is a flowchart of a preferred touch-based method for the display apparatus in accordance with a preferred embodiment of the present invention. In step S40, the processing unit 12 receives sensing signals from the sensing signal processing circuit 112 of the touch sensitive unit 111 in response to any touch operations on the touch sensitive unit 110. In step S41, the processing unit 12 recognizes the sensing signals from the touch sensitive unit 111 according to an associated coordinate therewith. In step S42, the processing unit 12 performs a corresponding operation according to the recognized sensing signals. For example, the processing unit 12 flips forwards a page of an electronic book displayed on the screen 10 if the sensing signals come from touch sensitive unit A1 or A4, conversely, flips backwards the page of the displayed electronic book if the sensing signals come from touch sensitive unit A2 or A3. Similarly, the processing unit 12 scrolls upwards the page of the displayed electronic book if the sensing signals come from touch sensitive unit B1 or B3, conversely, scrolls downwards the page of the display electronic book if the touch sensing signals come from touch sensitive unit B2 or B4.

Although the present invention has been specifically described on the basis of a preferred embodiment and preferred method thereof, the invention is not to be construed as being limited thereto. Various changes or modifications may be made to the embodiment and method without departing from the scope and spirit of the invention.

What is claimed is:

1. A display apparatus comprising a screen and a frame connected to the screen, wherein:
the frame comprises a plurality of touch sensitive regions, the touch sensitive regions each has a plurality of touch sensitive units, and each of the touch sensitive units generates sensing signals in response to a touch operation thereon, thereby performing a corresponding operation.

2. The display apparatus according to claim 1, wherein the touch sensitive regions are symmetrically disposed on the frame.

3. The display apparatus according to claim 2, wherein the touch sensitive regions are disposed on regions within a thumb's reach when holding the display apparatus.

4. The display apparatus according to claim 3, wherein the touch sensitive units of each touch sensitive region comprise a first touch sensitive unit, a second touch sensitive unit, a third touch sensitive unit, and a fourth touch sensitive unit, and each of the touch sensitive units has a coordinate for identification.

5. The display apparatus according to claim 4, wherein the first touch sensitive unit is for flipping forwards a page of an electronic book displayed on the screen, and the second touch sensitive unit is for flipping backwards a page of the displayed electronic book.

6. The display apparatus according to claim 5, wherein the third touch sensitive unit is for scrolling upwards the page of the displayed electronic book, and the fourth touch sensitive unit is for scrolling downwards the page of the displayed electronic book.

7. A touch-based method for a display apparatus, the method comprising the steps of: providing a display apparatus comprising a screen and a frame connected to the screen, the frame comprising a plurality of touch sensitive regions, the touch sensitive regions each has a plurality of touch sensitive units;
receiving and recognizing sensing signals from the touch sensitive unit of the touch sensitive region, in response to a touch operation thereon; and
performing a corresponding operation, according to the recognized sensing signal.

8. The touch-based method according to claim 7, wherein the touch sensitive regions are symmetrically disposed on the frame.

9. The touch-based method according to claim 8, wherein the touch sensitive regions are disposed on regions within a thumb's reach when holding the display apparatus.

10. The touch-based method according to claim 9, wherein the touch sensitive units of each touch sensitive region comprise a first touch sensitive unit, a second touch sensitive unit, a third touch sensitive unit, and a fourth touch sensitive unit, and each of the touch sensitive units has a coordinate for identification.

11. The touch-based method according to claim 10, wherein the step of performing a corresponding operation according to the recognized sensing signal further comprises the steps of:
flipping forwards a page of an electronic book displayed on the screen if the sensing signals from the first touch sensitive unit; and
flipping backwards a page of the displayed electronic book if the sensing signals from the second touch sensitive unit.

12. The touch-based method according to claim 11, wherein the step of performing a corresponding operation according to the recognized sensing signal further comprises the steps of:
scrolling upwards the page of the displayed electronic book if the sensing signals from the third touch sensitive unit; and
scrolling downwards the page of the displayed electronic book if the sensing signals from the fourth touch sensitive unit.
